(19) United States
(12) Patent Application Publication
(10) Pub. No.: US 2026/0216544 A1
(43) Pub. Date: Jul. 30, 2026

(54) Battery Bag and Compartment Packet Chemical Fire Suppression Systems

(71) Applicant: Stephen Knight, Oklahoma City, OK (US)

(72) Inventor: Stephen Knight, Oklahoma City, OK (US)

(21) Appl. No.: 18/831,459

(22) Filed: Jan. 28, 2025

(51) Int. Cl. A62C 35/10; A62C 3/16; H01M 10/0525; H01M 10/613; H01M 10/623; H01M 10/6567

(52) U.S. Cl. CPC A62C 35/10; A62C 3/16; H01M 10/0525; H01M 10/613; H01M 10/623; H01M 10/6567; H01M 2200/10; H01M 2220/30

(57) ABSTRACT

A method a process for extinguishing and halting a thermal runaway event of an internal ionic battery within an electronic device providing an internal fire suppression packet containing fire suppression chemical within the electronic device or alternatively providing a fire-proof bag with a burstable internal pouch containing a fire suppression chemical to drawn a larger electronic bag placed within and sealed within the fire-proof bag.

### CROSS REFERENCE TO RELATED APPLICATIONS

None.

### I. Background of the Invention

### 1. Field of Invention

An ionic battery extinguishing liquid which is applied to a failing ionic battery, upon sensing a predetermined level of heat, floods the errant ionic battery with an extinguishing liquid which inactivates the ionic battery and both extinguishes and terminates any further increase in heat level of the ionic battery and the electronic device and deactivates the ionic battery by halting the exchange of cathode-anode electronic current supply, being contained in either a heat decaying packet within the ionic batter cavity of the electronic device or supplied in a fire proof containment bag with the extinguishing liquid contained in a suspended packet within the bag subject to perforation or rupture by forceable contact to release the liquid within the bag.

### 2. Description of Prior Art

A preliminary review of prior art patents was conducted by the applicant which reveal prior art patents in a similar field or having similar use. However, the prior art inventions do not disclose the same or similar elements as the present battery fire suppression system, nor do they present the material components in a manner contemplated or anticipated in the prior art.

In U.S. Pat. No. 11,289,731 to He, a lithium secondary batter containing an anode, a cathode, a porous separator electrolyte element disposed between the cathode and anode and a cathode protecting layer bonded or adhered to the cathode with the cathode protecting layer comprising a lithium ion-conducting polymer matrix or binder and inorganic material particles that are dispersed in or chemically bonded by the polymer matrix, melts, contracts or collapses when under extreme heat causes by dendrite or nail penetration prevents massive internal shorting or fire. An emergency water bath container is disclosed in U.S. Pat. No. 10,722,741 to Lian, which contains an amount of water within a boxed container with a lid, which may enclose a failing battery, which heats the water and causes a breakdown of a pouch containing a fire-fighting foaming agent which, when released from a cartridge at an elevated heat caused by introduction of the battery within the water, mixes with the water and suppresses further elevated heat from the battery.

In a first Korean patent, as best translated from the issued patent publication of KR 20070008087, (inventor unknown) a lithium secondary battery comprises a thermally degrading capsule containing an anti-overcharging agent which increase an inner resistance or impedance of the battery by electrochemical polymerization of abnormal working condition of the battery, wherein the anti-overcharging agent is one or more from the group consisting of biphenyl, terphenyl and cyclohexyl phenyl. A second Korean patent, as best translated from the issued patent publication of KR102064416B1, (inventor unknown), a lithium-based fire extinguishing agent is used to extinguish a fire from lithium based batter and includes a powdered fire extinguishing agent, a solid aerosol extinguishing agent and a liquid fire extinguishing agent. An included method using the ingredients sprays the solid aerosol extinguishing agent by vaporizing the solid aerosol agent with the extinguishing gas from a solid aerosol extinguishing part, sprays the powder fire extinguishing agent and sprays the liquid extinguishing agent when the fire occurs in the lithium-based battery. In JP6042734B2, which appears to have been filed by Hochiki Corp. an published on Dec./14/2016, discloses a cabinet wherein a lithium-ion battery which is deactivated using an explosive powder, disclosed as gunpowder, is exploded within the container creating a percussive extinguishment of any potential lithium-ion battery fire event. In a Chinese patent, published in 2021 as CN109316687B to Huawei Technologies Co. Ltd., a battery management system discloses a gas sensor detecting the presence of explosive gasses from a battery module, such gases including Hydrogen, methane, ethane, ethylene and carbon monoxide, which further activates a discharge of fire extinguishing gases to the battery when the limits of acceptable level of explosive gases is reached.

None of the previous art discloses a device having the liquid extinguishing agent as disclosed in the present invention which is intentionally released at a certain pre-determined thermal limit upon the cathode and anode portion of ionic battery to flood the battery containing compartment of an electronic device by a thermal to decay the thermal decaying packaging or a fire proof container or envelope having an internal packaged liquid extinguishing agent, the container or envelope containing an electronic device with an immediate defective ionic battery event wherein the internal packaged liquid extinguishing agent is released by rupture of the internal packaging.

### II. Summary of the Invention

Ionic batteries are seeing a rapid rise in the market to provide stored electrical energy for everything from medical device, small electronics, rechargeable vehicles and even large electronics and home energy storage. Metal ion batteries comprise essentially four components. The cathode stores the metal ions and releases charged ions when the battery is charging. The anode releases ions when the battery is discharging. A separator provides movement from the anode to the cathode while preventing a short circuit. An electrolyte acts as a transporter of ions within the ionic battery during charging and discharge use. At present, the most used ionic battery is the lithium-ion battery. These batteries have the capability to be charged and discharged multiple times, each charge and discharge called a cycle, and lithium has a very high number of cycles over its lifetime. Sodium is being developed and other reactive metals which are being developed include potassium, magnesium, calcium, zinc and aluminum. Most common use at this time would be the present suppression as it relates to lithium-ion batteries, but in the event these other metallic ion batteries would have a potential for ignition or fire hazard, it is contemplated that the present suppression materials and systems might be employed synonymously with those metal ion batteries, also.

It is well known in the metal-ion industry that fires can occur as a direct result of ionic batteries catching fire or obtaining a level of heat which would ignite surrounding materials. This event is known in the industry as thermal runaway, which is caused by an initiation event. It is a phenomenon in which a lithium-ion cell enters a state of uncontrolled self-heating. If the excessive heat generation is not halted, the condition will worsen into a chemical reaction that further releases thermal energy, melting the separator causing an internal short circuit. This is the tipping point after which the thermal runaway occurs in a continuous feedback loop. This commonly causes an ignition of other adjacent cells, propagating these other cells into a thermal runaway and destroy an entire battery pack. Causes of these thermal runaways can be initiated by environmental means, including excessive heat, charging in a cold environment, or exposure to salt water. Mechanical disruption caused by dropping, crushing, indenting, chocking, vibration, impact or penetration can cause separator failure. Electrical overcharge is a potential initiating event as is electrical over-discharge. Manufacturing and design defects from cheaply made batteries are a known reason for lithium-ion battery fires. Aging or use beyond the life of the battery may also cause a fire event and failure.

All of these above causes of thermal runaway must be considered and the present components, materials and processes disclosed are intended to address these thermal runaway damages and minimize the risk of metal ion battery fires and damage to not only electronic devices but surrounding environments wherein these electronic metal ion battery devices are used, including transportation vehicles during passage or transport.

### III. Description of the Drawings

The following drawings are submitted with this utility patent application.

FIG. 1 is a perspective view of a portable hand-held electronic device indicated as a cell phone.

FIG. 2 is a sectional view of FIG. 1 along section lines 2/2, indicating a battery compartment containing an ionic battery with a first embodiment of a low melting point chemical fire suppression packet in a ready state above the ionic battery containing the suppressant solution.

FIG. 3 is the same sectional view as FIG. 2 subsequent to a runaway thermal event showing the chemical fire suppression packet having melted flooding, the battery compartment with the chemical fire suppression liquid to eliminate the chemical runaway event.

FIG. 4 is a side view of a second embodiment of a fire-proof bag defining an envelope within which is suspended an internal bag of a chemical fire suppression liquid in a ready state for placement of a larger electronic device which is experiencing a runaway thermal event for safe and contained extinguishment.

FIG. 5 is a cross-sectional view along section lines 5/5 of FIG. 4, of the fire-proof bag with the internal bag of chemical fire suppression liquid suspended by a suspension means to attach the internal bag to a wall within the envelope in a ready state in prior to the placement of a larger electronic device prior to a runaway thermal event or ionic battery fire.

FIG. 6 is a view of the fire-proof bag containing a larger electronic device, shown in phantom lines, within the envelope having the internal bag ruptured by an impact to release the chemical fire suppression liquid into the envelope to saturate and drown the larger electronic device and its internal ionic battery power supply.

### IV. Description of the Preferred Embodiment

Ionic battery thermal runaways have been a common occurrence since the advent of this type rechargeable battery introduction into electrical device. Most common are the lithium-ion batteries which have the capacity to be recharged repeatedly over their useful lives-upward of 10,000 recharges before they become depleted. New ionic batteries are currently under development with hopes for a newer and better rechargeable battery. It is also a less common occurrence that these batteries can become defective as previously highlighted, resulting in thermal runaway events and even a consuming fire that destroys not only the electronic device, but surrounding combustible materials in near proximity. Damage to the battery, overheating or extreme conditions can lead to breakdown of the Solid Electrolyte Interphase (SEI) layer on the anode, which starts at around 167° F. (75° C.). As the SEI layer disintegrates, heat is generated through chemical reactions. The anode reaction produces heat exponentially, raising the temperature. At approximately 230° F. (110° C.), the organic solvents in the electrolyte break down, releasing flammable gases. Several reactions occur during this thermal runaway event, as follows:
a. Decomposition of the SEI Layer: The SEI layer decomposes, releasing gases and heat.
b. Electrolyte Decomposition: Organic solvents in the electrolyte break down, producing flammable gases like ethylene.
c. Lithium Reaction with Solvent: Lithium ions can react with the solvent, generating heat and additional lithium salts.
d. Short Circuit Reaction: When the separator melts, a short circuit occurs between the anode and cathode, discharging energy uncontrollably.
e. Decomposition of Cathode Materials: The metal oxide cathode starts to decompose, releasing oxygen gas that can fuel combustion.
f. Formation of Toxic Gases: Additional toxic gases may form from the decomposition of materials, creating hazardous conditions.
g. Combustion Reactions: The released flammable gases ignite, leading to combustion that sustains the fire.

This has been proven and is commonly the manner in which lithium-ion batteries react in the thermal runaway occurrences.

In addition, pressures may build up in the batteries during the runaway thermal event which can result in a explosion, which may include the following:
a. Gas Production: The electrolyte decomposition and the SEI layer generate flammable gases. As these gases accumulate, they increase the battery cell's internal pressure.
b. Electrolyte Breakdown: The breakdown of organic solvents in the electrolyte forms additional gases, further increasing pressure.
c. Melting of the Separator: When the polymer separator melts due to high temperatures, it can cause a short circuit, leading to rapid energy discharges and further gas generation, exacerbating pressure buildup.
d. Thermal Expansion: The heat generated from the reactions causes the gas within the battery to expand, increasing the pressure even more.

Dangers which can result from excessive heat and temperature have been know to pose the following risk to the local area as well as to the environment. These critical risks may include:
a. Risk of Explosion: High internal pressure can rupture the battery casing, potentially causing an explosion that can spread fire and toxic materials.
b. Fire Propagation: If the battery bursts, it can release flammable gases and materials into the environment, igniting nearby combustibles and escalating the situation.
c. Safety Hazard for Firefighters: Understanding pressure buildup helps firefighters anticipate the potential for violent reactions and explosions, allowing them to take appropriate precautions and measures when responding to incidents involving lithium-ion batteries.
d. Compromised Containment: Once the battery's structural integrity is compromised, containment becomes difficult, making it essential to manage pressure effectively to prevent further hazards.

The solution, components and methods of use as disclosed below are intended to stop the thermal runaway upon immediate presentation to the ionic battery or device containing the ionic battery in the following physical and chemical manners. First, there is an immediate cooling effect. The specialized solution used in firefighting is highly endothermic, meaning it absorbs heat from the battery almost instantly. This cooling effect helps slow down the chemical reactions that generate heat. Second, by neutralization of the electrolyte when the solution penetrates the affected battery cells and disrupts the combustion reactions within the electrolyte. By neutralizing the electrolyte, it halts the chemical processes that contribute to further heat generation. Third, by the formation of a porous chemical barrier that condenses and traps the toxic gases produced during thermal runaway. This barrier helps prevent the spread of heat and additional reactions within the battery, reducing the risk of fire spreading to surrounding materials. Fourth, by stabilizing the battery or device containing the battery after extinguishing the fire, injecting a more viscous solution stabilizes the battery, minimizing the risk of further mechanical failures and potential reignition during transport.

Having identified the risk and circumstances encountered with ionic batteries and the devices operated by these batteries, the present chemical fire suppression system involves the use of an electrochemical ionic fire suppression liquid 10, preferably liquid ethylene glycol monophenyl ether (hereinafter, EGME identifying the electrochemical ionic fire suppression liquid as reference number 10), a/k/a 2-Phenoxyethanol, which is a stable liquid chemical known for its wetting qualities and which is not considered hazardous by the 2012 OSHA Hazard Communication Standards, 29 CFR 1919.1200. It is further described as a Florine Free Solution used in extinguishing Lithium-ion fires. It is not listed as an extremely hazardous substance (SARA Section 355), is not listed as a toxic chemical (SARA Section 311/312/313), is not listed as a Hazardous Air Pollutant (HAPs), and is not listed as a toxic chemical (Toxic Substances Control Act).

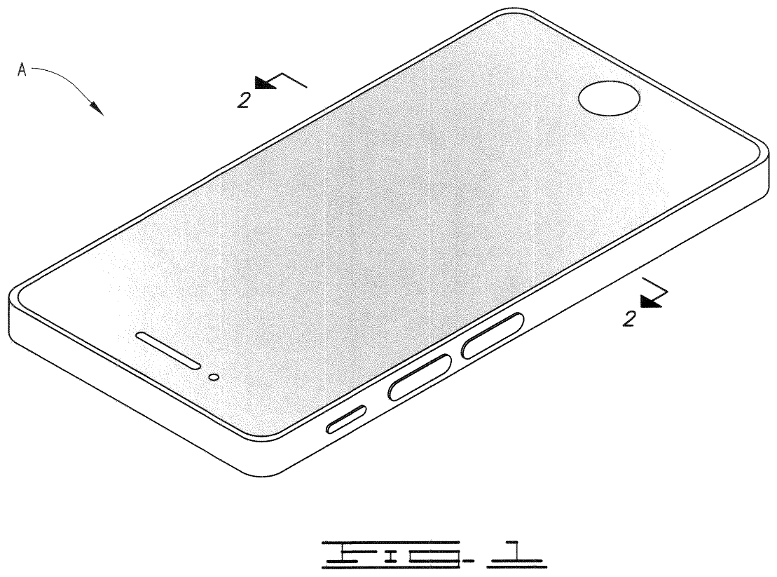

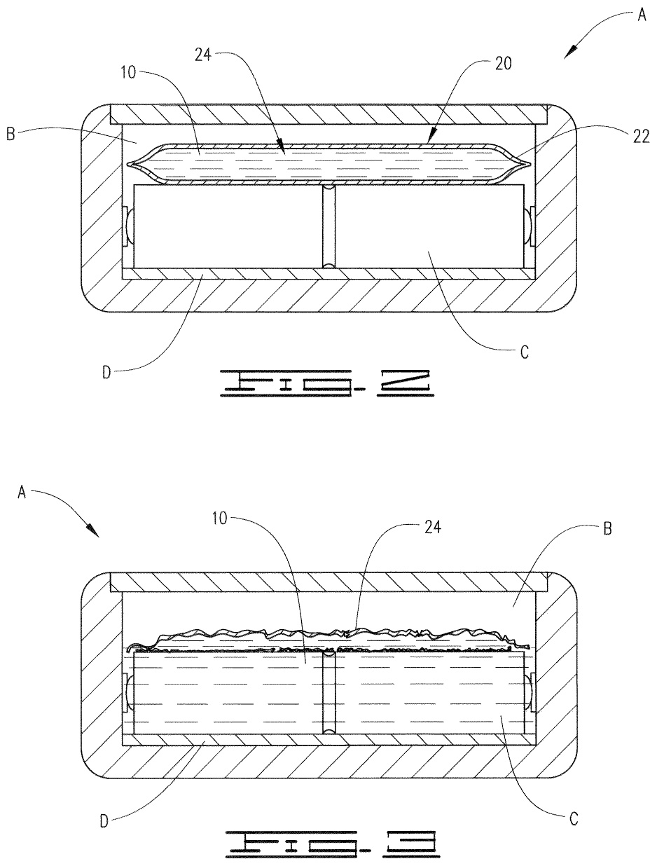

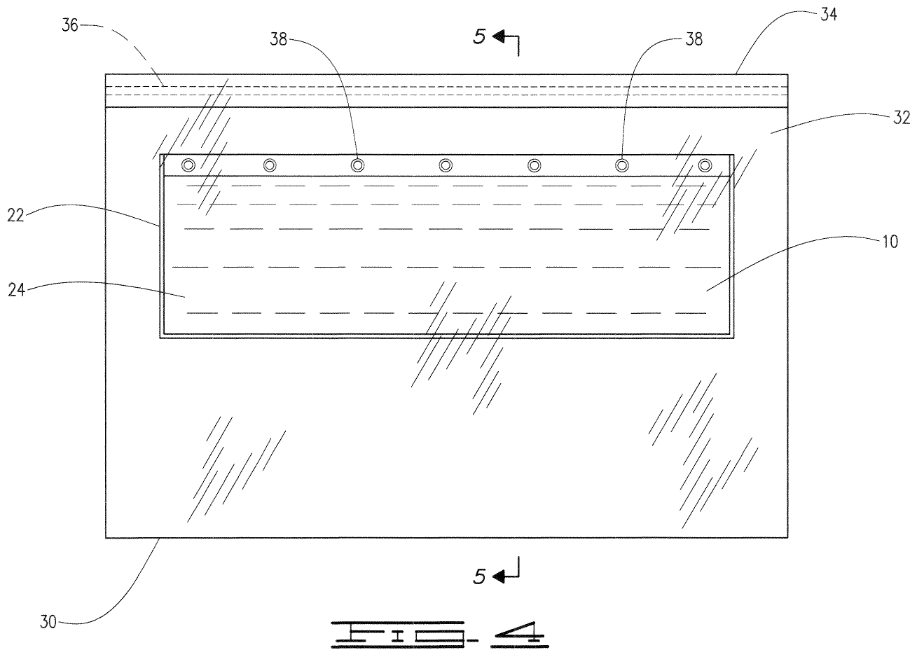

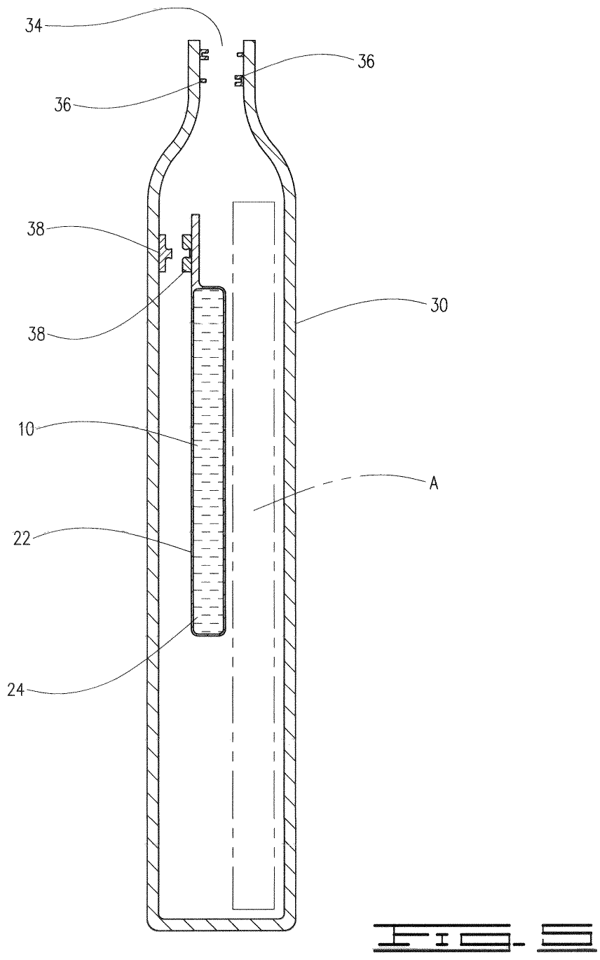

The EGME 10 is contained within various quantity sized low thermal degrading plastic packets 20 forming a polymorph plastic envelope 22 defining an internal cavity 24, in a first embodiment, FIGS. 1-3, to be installed within a battery compartment B of an electronic device A in close proximity to at least one ionic battery C, or in a much larger quantity in a polymorph plastic envelope 22 defining an internal cavity 24 suspended within a fire-proof bag 30, FIGS. 4-6, which can accept an electronic device A containing one or more ionic batteries C. For purpose of this specification and claims, we are going to reference the Lithium-ion battery, but it should be recognized that this will include all types of ionic batteries currently existing or in the process of development having the same or similar characteristics of the Lithium-ion rechargeable batteries and the physical electrical characteristics of the Lithium-ion batteries.

As previously indicted in the specification, the present first embodiment, FIGS. 1-3, provides the EGME 10 in the small polymorph plastic envelope 22 defining the internal cavity 24 that has a known low melting point somewhere between normal ambient air temperature at normal operation of an electronic device A and an elevated temperature which would occur during a thermal runaway event of the Lithium-ion battery C, causing the small polymorph plastic envelope 22 to melt and deploy its EGME 10 content to be expelled into the battery compartment B to flood and saturate the Lithium-ion battery C and halt the thermal runaway event. From a physical-chemical event, the EGME 10 would flood the Lithium-ion battery C to basically kill the Lithium-ion battery C. Polymorph plastic has a working temperature of around 60 degrees Celsius and can be formed at room temperature, similar to nylon. It is also biodegradable. Specific examples include polycaprolactone (PCL), which melts at 42 degrees Celsius, probably most suited for the heat degrading polymorph plastic envelope 22, since the PCL comes in suitable sheets and mesh.

EGME 10 is known to those skilled in the art of ionic batteries C, to halt the exchange of ions within a Lithium-ion battery by interrupting the exchange of ions between the cathode and anode, across the separator and within the electrolyte liquids. This effect is nearly instantaneous once the Lithium-ion battery C has been flooded with the EGME 10. It may be necessary, in order to preserve the electronic device A after the thermal runaway event has been abated, to line the battery compartment B with some type of liquid barrier D to prevent the liquid EGME 10 from damaging the other electrical components contained within the electronic device A, especially those in close proximity to the battery compartment B containing the Lithium-ion battery C, as determined by the manufacturer.

In a second embodiment, FIGS. 4-6, the same EGMA 10 is used and placed in another larger polymorph plastic envelope 22 which is attached inside the fire-proof bag 30, the present polymorph plastic envelope 22 defining an internal cavity 32 with an upper opening 34 and upper closure means 36. A larger quantity of EGMA 10 is held within the larger polymorph plastic envelope 22, the envelope being ruptured or quickly burst to release the EGMA 10 by impact, by rapid compression, or by being exposed to heat of the nearby electronic device A at the moment of use. This second embodiment is intended to take an entire electronic device A containing a thermal runaway ionic battery C which is either incapable being opened to expose the battery compartment B or is too hot to handle to gain access to the battery compartment B at the time, placing the entire electronic device A within the upper opening 34 of the fire-proof bag 30, sealing the upper closure means 36 of the fire-proof bag 30 and releasing the EGMA 10 from the suspended polymorph plastic envelope 22, hopefully extinguishing the fire potential by suffocation, flooding of the electronic device A within the fire-proof bag 30, surrounding the rising temperature electronic device A with the free flowing bath of EGMA 10, further shaking the closed fire proof bag 30 until the heat event is abated. Most likely, this second embodiment is most likely going to destroy the electronic device A, but in an airplane event, which has occurred, during train travel or during automobile travel, this can prevent a hazardous expanded or contagious fire event.

The fire-proof bag 30, FIGS. 4-6, would be made from a fire proof materials selected from a group comprising Aramid (400 degree F.), fiberglass fabric (up to 1000 degree F.), Silica fabric (up to 2000 degree F.), and Alumina (up to 2300 degree F.). These selected fire proof materials may also include blended fabric compositions including ceramic oxide insulation fabrics combined with woven fiberglass, aluminized fabrics, Z-BLOCK ® flame retardant fabrics. Z-SHIELD® acrylic coated welding fabrics, Z-TUFF® silicone fabrics, and even well-known fabrics like KEVLAR®. The fire-proof bags 30 would best provided as seamless enclosed bags with the secure and the airtight upper closure means 36 also made of a heat resistant material.

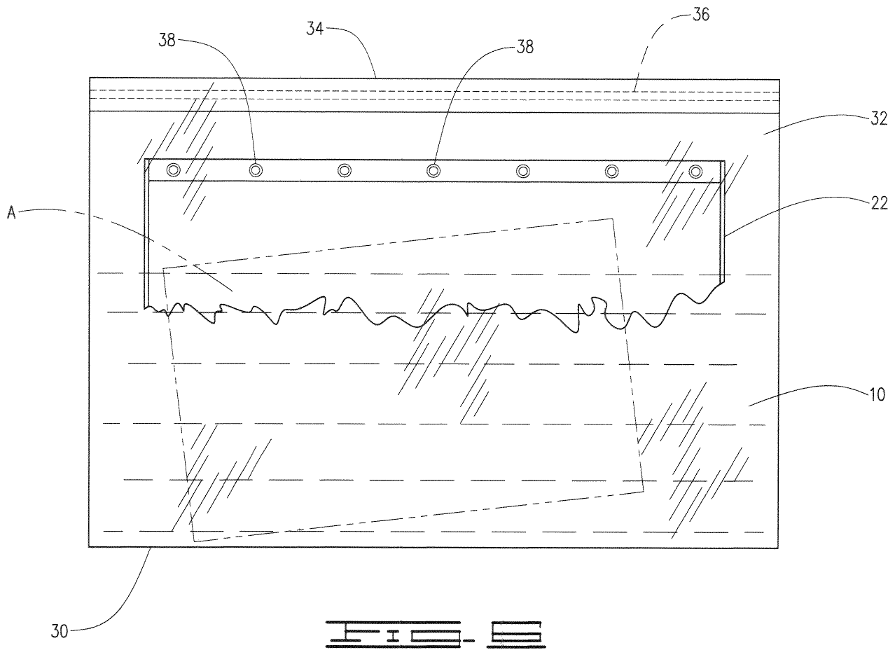

The polymorph plastic envelope 22 is attached within the internal cavity 32 by a plurality of envelope attaching means 38, intended for replaceable polymorph plastic envelopes 22 filled with refreshed EMSA 10, providing the second embodiment for reuse after a thermal runaway event. This second embodiment fire-proof bag 30 would be designed to contain heat, liquid and block any supply of fresh air using every means possible to avert and suppress an active fire event. In FIG. 5, an example of an envelope attaching means 38 is shown as a plurality of snap connections.

Alternative fire suppressant liquids 10, in addition to the EGME may include other wetting agents having ion exchange suppression characteristics which may be used in place of the EGME could include wetting agents selected from a group comprising phenoxyethanol, phenoxytolarosol, DOWANOL® EP/EPH, Protectol PE, Emery 6705, rose ether, 1-Hydroxy-2-phenoxyethane, β-hydroxyethyl phenyl ether, phenyl cellosolve, PHENOXETOL® or phenetole, although these alternatives may have different effects upon personal contact or the environment and may also product toxic results over pronged contact.

While the electrochemical fire suppression liquids 10 and polymorph plastic envelopes 22 have been particularly shown and described with reference to a preferred embodiment thereof, it will be understood by those skilled in the art that changes in form and detail may be made therein without departing from the spirit and scope of the invention.

What is claimed is:

1. An ionic battery fire suppression system for extinguishing a runaway thermal event in a battery compartment of an internal electronic device operated by an ionic battery, comprising:
a low thermal degrading plastic packet formed from a polymorph plastic envelope defining an inner cavity and located within said battery compartment containing said ionic batter within said electronic device; and
said inner cavity containing an electrochemical fire suppression liquid, wherein said low thermal degrading plastic packed decays in the presence of heat generated by said runaway thermal event, releasing said electrochemical fire suppression liquid within said batter compartment, immersing said ionic battery within said electrochemical fire suppression liquid thereby terminating said runaway thermal event.

2. The ionic battery fire suppression system of claim 1, wherein said polymorph plastic envelope is made from polycaprolactone (PCL), having a melting point of approximately 42° C. or a substantial equivalent plastic having a similar melting point temperature.

3. The ionic battery fire suppression system of claim 1, wherein said electrochemical fire suppression liquid is liquid ethylene glycol monophenyl ether, a/k/a 2-Pheoxyethanol.

4. The ionic battery fire suppression system of claim 1, wherein said electrochemical fire suppression liquid is selected from a group of wetting agent liquids comprising phenoxyethanol, phenoxytolarosol, DOWANOL® EP/EPH, Protectol PE, Emery 6705, rose ether, 1-Hydroxy-2-phenoxyethane, β-hydroxyethyl phenyl ether, phenyl cellosolve, PHENOXETOL® and phenetole.

5. An ionic battery fire suppression system for extinguishing a runaway thermal event in a battery compartment of an electronic device operated by an ionic battery, comprising:
a fire proof bag defining an internal cavity, an upper opening, an upper closure means and an envelope attaching means within said internal cavity; and
a polymorph plastic envelope defining a sealed internal cavity containing a quantity of electrochemical fire suppression liquid, said polymorph plastic envelope suspended within said internal cavity of said fire proof bag by said envelope attaching means, wherein said electronic device operated by said ionic battery experience a thermal runaway event is placed within said inner cavity after which said fire proof bag is sealed by said upper closure means, said polymorph plastic envelope is rupture to release said electrochemical fire suppression liquid within said internal cavity, drowning said electronic device within said electrochemical fire suppression liquid, and terminating said runaway thermal event.

6. The ionic battery fire suppression system of claim 5, wherein said electrochemical fire suppression liquid is liquid ethylene glycol monophenyl ether, a/k/a 2-Pheoxyethanol.

7. The ionic battery fire suppression system of claim 5, wherein said electrochemical fire suppression liquid is selected from a group of wetting agent liquids comprising phenoxyethanol, phenoxytolarosol, DOWANOL® EP/EPH, Protectol PE, Emery 6705, rose ether, 1-Hydroxy-2-phenoxyethane, β-hydroxyethyl phenyl ether, phenyl cellosolve, PHENOXETOL® and phenetole.

8. The ionic battery fire suppression system of claim 5, wherein said fire proof bag and upper closure means is a seamless enclosed bag, said upper closure means forms an airtight seal and both said fire proof bag and said upper closure means are made of a material selected from a group comprising Aramid (400 degree F.), fiberglass fabric (up to 1000 degree F.), silica fabric (up to 2000 degree F.), alumina (up to 2300 degree F.), ceramic oxide insulation fabrics combined with woven fiberglass, aluminized fabrics, Z-BLOCK ® flame retardant fabrics, Z-SHIELD® acrylic coated welding fabrics, Z-TUFF® silicone fabrics, and KEVLAR®.

9. An ionic battery fire suppression system for extinguishing a runaway thermal event in a battery compartment of an electronic device operated by an ionic battery, comprising any other component or combination of components as disclosed in the specification and drawings.
